(19) United States
(12) Patent Application Publication
(10) Pub. No.: US 2007/0179951 A1
(43) Pub. Date: Aug. 2, 2007

(54) Content Acquisition and Management System and Method

(76) Inventor: Aldo Monteforte, Milan (IT)

Correspondence Address: FENWICK & WEST LLP, SILICON VALLEY CENTER, 801 CALIFORNIA STREET, MOUNTAIN VIEW, CA, 94041, US

(21) Appl. No.: 11/627,560

(22) Filed: Jan. 26, 2007

Related U.S. Application Data
(60) Provisional application No. 60/763,817, filed on Jan. 30, 2006.
(60) Provisional application No. 60/798,136, filed on May 4, 2006.

(51) Int. Cl. G06F 17/30

(52) U.S. Cl. 707/6

(57) ABSTRACT

A content acquisition and management system (CAMS) and method to enable acquisition of printed content for subsequent management. In one embodiment, the invention includes a portable device that is capable of communicating with one or more server(s) and digital content databases. The server(s) has the ability to recognize partial information or content captured and transmitted by the portable device and match it against a full, original content contained in one or more digital databases. The system generates benefits in terms of enhanced productivity and convenience for at least three constituencies: information and content users, publishers and advertisers.

### RELATED APPLICATIONS

This application claims priority from U.S. provisional application No. 60/763,817, filed on Jan. 30, 2006 and U.S. provisional application No. 60/798,136 filed on May 4, 2006 which are incorporated by reference herein in their entirety.

### FIELD OF INVENTION

This invention is related to the field of data retention and more particularly to digital acquisition and management of printed information and content.

### BACKGROUND OF THE INVENTION

For centuries individuals have used printed media to store and transmit knowledge and information. Currently, a person wishing to retain information (be it text or image) captured in a printed medium generally has the following options: (1) read and memorize the information, (2) file a paper document (original or photocopy); or (3) scan paper into a digital file.

These options have certain disadvantages. Using human memory entails the risk of forgetting valuable information. Human memory, while extremely flexible, has certain limits when it comes to storing information presented in textual or image format. For example we may easily remember reading something insightful about recent economic developments in China, or about certain critical issues faced by a pharmaceutical company in the process of getting drug approval. However, if recalling where and when certain information was received may be challenging, remembering exactly the fine details of a reading may be impossible. But in certain situations, for example when information is necessary to reach a better decision, rapidly and exactly retrieving those details may become very valuable.

Keeping a paper document presents other disadvantages: paper's physical nature makes the storing, indexing, categorizing, prioritizing, retrieving and manipulating of information messy and inconvenient. Management of printed information and content is time-consuming, hence costly. Inefficient management increases the probability of losing or misplacing valuable information. Last but not least, the production of paper involves the consumption of scarce natural resources and a related impact on the environment.

For example, during a flight a manager may read an article about new market opportunities or a competitor's move. He might want to share it with colleagues and/or make a copy of the article for filing. This would require managing the “paper” article from the airplane to the office and taking a number of time consuming steps necessary to adequately store and share the information.

By definition, consumption of printed content can only happen in the act of reading it. however, many situations exist when visual attention is already absorbed by critical activities, e.g., driving, walking or exercising, and reading is either impossible or unsafe. Still, the possibility of “consuming” content in these situation could make one's life fuller and more productive.

The scanning alternative is not widespread because of the size and cost of fixed scanning equipment. Common scanning equipment is suited for home or office applications and not for portable uses. Recently, NEC of Japan announced the intention to upgrade the functionalities of mobile phones providing them with scanning and faxing capabilities. In particular, NEC and the Nara Institute of Science and Technology (NAIST) in Japan, are working on cell phone camera technology that allows entire documents to be scanned simply by sweeping the phone across the page. “The goal of our research is to enable mobile phones to be used as portable faxes or scanners that can be used any time,” an NEC spokesman told New Scientist.

While helpful in capturing content on the fly, just like portable scanners, this technology merely makes a traditional scan or fax into a portable tool. However, it does not enable the user to manage and manipulate the information that has been scanned or faxed. In addition, there are copyright concerns regarding such portable scanning technology. Since portable scanners will make it possible to make copies without even purchasing the original.

The methods for retaining content captured in printed media discussed above generate significant disadvantages, not only for the users of the information, but also for two further constituencies: print publishers and advertisers.

Print publishers have packaged the information and own valuable rights to it. Although copyright protected, printed content is frequently copied without permission and is difficult to protect. In addition, print publishers find it difficult to obtain real time data on individuals' consumption of specific printed content. For example, publishers of the publication know how many copies of the current issue have been sold. However, there is no way to know which specific articles have generated the most interest at a specific instant and over a period of time. Understanding, as the reading occurs i.e., in real time or in close to real-time, what specific thematic content is of interest to which individual reader is equally difficult, if not impossible. In the case of the flying manager above, there would be no way for the publisher to know if that specific individual is curious or inspired by a particular subject. However, this information would be very valuable, as it would be to know the community with whom that manager is interested in sharing the article.

As for advertisers, they are interested in profiling individuals according to their preferences in order to make more effective marketing offers. Currently, there is no way for advertisers to infer, in real time (or close to real-time), the preferences of individual readers. Equally, there is no mechanism enabling a consumer to make real time contact with an advertiser upon viewing a desirable object exposed on printed material.

Accordingly, what is needed is a comprehensive solution to the disadvantages described above and borne by users, publishers and advertisers in the process of acquiring and managing printed content.

### SUMMARY OF THE INVENTION

A purpose of the content acquisition and management system (CAMS) and method is to enable acquisition of printed content for subsequent management and consumption. In one embodiment, the invention includes a portable device that is capable of communicating with one or more server(s) and digital content databases. The server(s) has the ability to recognize partial information or content captured and transmitted by the portable device and match it against a full, original content contained in one or more digital databases. The system generates benefits in terms of enhanced productivity and convenience for at least three constituencies: information and content users, publishers and advertisers.

Some of the benefits for information and content users are: (1) the ability to digitize printed content on the fly for subsequent management, consultation and sharing; (2) providing web-based access to personally selected content residing on secure central servers (or on a server selected by a user); (3) the option to consume content through video and/or audio, e.g., a podcast; (4) easy retrieval, secure storage, and searching capability of the content; (5) automatic categorization and indexation of content; (6) ability to access additional content, based on relevance, coming from partnering publishers or available on the Internet; (7) ability to build and deploy a personal supply chain of information, knowledge and entertainment; (8) becoming a more self directed and empowered researcher, editor and selector of knowledge.

Some of the benefits for publishers are: (1) obtaining a server mediated, real time access to analytical information on who is acquiring what content, when & how frequently; (2) having the ability to structure and offer highly targeted editorial and advertising content to more likely buyers, based on content acquisition patterns (for example, publishers can ask a user if he/she would like to be informed when something new on a certain subject is published again); (3) having the ability to attract advertisers seeking to address tightly targeted messages to neatly profiled audiences; (4) offering customers wider enjoyment and utilization of content (content effectively becomes medium independent); (5) greater control over copying of content; (6) providing competitive differentiation, from other content providers.

Some of the benefits for advertisers include: (1) obtaining a server mediated, real time access to analytical information on who is acquiring what content, when & how frequently; (2) obtaining access to highly profiled customers and to their interests based on content acquisition pattern and having the ability to address specific messages to more interested audiences; (3) having the ability to address individual prospects after they have acquired specific advertising content, signaling high degree of interest.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 provides an overview of the architecture the CAMS system in accordance with one embodiment of the present invention.

FIG. 2 provides a view of the functions performed by the server in accordance with one embodiment of the present invention.

### DETAILED DESCRIPTION OF THE INVENTION

A preferred embodiment of the present invention is now described with reference to the figures where like reference numbers indicate identical or functionally similar elements.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

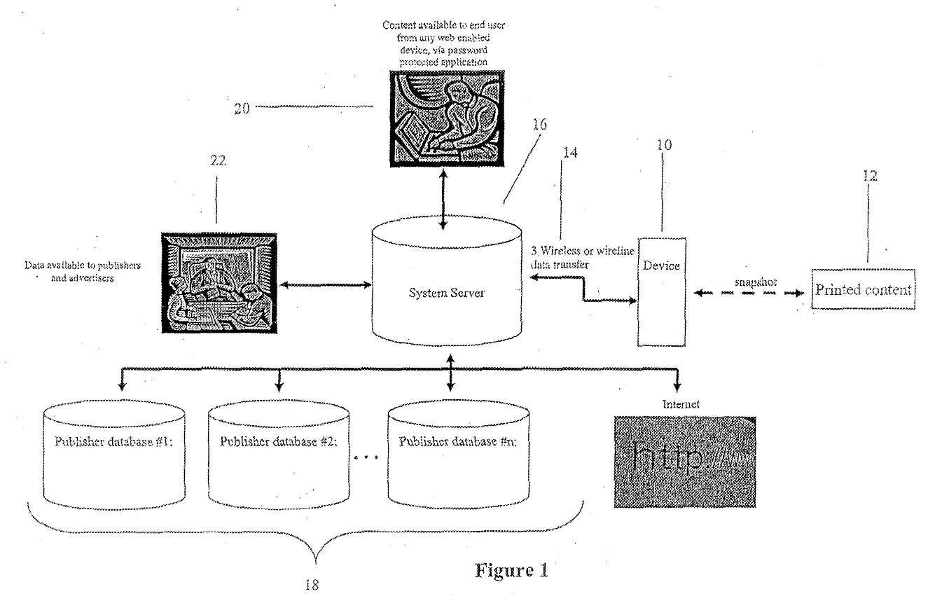

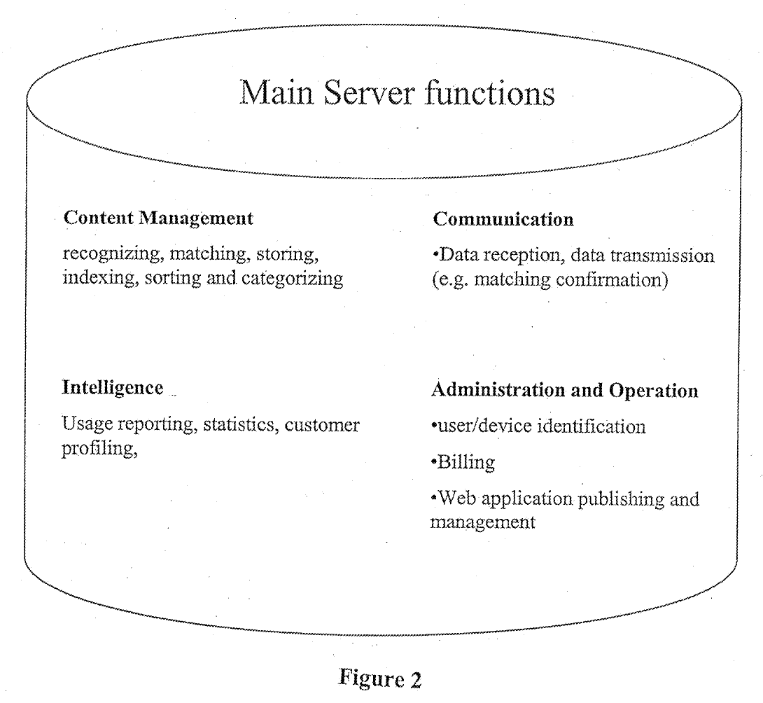

FIG. 1 provides an overview of the architecture the CAMS system in accordance with one embodiment of the present invention. FIG. 2 provides a view of the functions performed by the server in accordance with one embodiment of the present invention. Device 10 (FIG. 1) is a portable client integrating the following components: (1) miniaturized camera with auto focus and auto flash; (2) power supply e.g., battery; (3) wireless connection engine; (4) wire-line connection engine; (5) antenna; (6) laser pointer; (7) a screen or, if absent, beeper/buzzer or light; (8) memory. In alternate embodiment one or more of the above are not present in the device 10.

In various embodiments the client is either stand-alone device or is integrated into an existing portable device (like a mobile phone, smart phone, personal digital assistant (PDA) or I-pod). If stand-alone, it would be preferably light, highly appealing and comfortable to use and carry.

The acquisition of printed information or content can be accomplished by having the user aim the device at any point of the target material 12 (FIG. 1) followed by clicking or other selection procedure. In one embodiment a laser pointer integrated into the device assists in the process. The laser light helps the user position the camera's focal point in an adequate angle to the printed material. The laser may illuminate a point or a region of the printed text corresponding to the actual snapshot. This assists the user in storing enough content (be it words or images) to increase the chances of a successful matching. It is envisioned that other aiming features (or none) can be used. In other embodiments the device 10 does not have a laser.

The device 10 optionally has a screen. If a screen is present, a short message may be dispatched to the user confirming successful completion (or failure) of the matching process. The confirmation message may contain key information about the stored content (like, in the case of an article, title, author, publication and date). Similarly, the screen can provide feedback to the user regarding the positioning of the device 10 in order to properly acquire the printed publication, i.e., this can be used in addition to or in place of the laser. If a screen is absent, a light or a buzzer can perform the confirmation. Alternatively, the confirmation message may be dispatched to the user's mobile phone or email address.

The device 10 is enabled to transfer the captured data wirelessly 14a. In other embodiments the device 10 may transfer the data through a wire-line connection 14b (for example, obtained by positioning the device in a cradle).

The device 10 can hold sufficient memory to store the acquired content for all situations where no telecom connection exists (like on an airplane). As a connection is re-established, the content can be transferred automatically to the central server without user intervention.

As indicated in FIGS. 1 and 2, the portable device 10 transfers the acquired content to a dedicated, secure central server 16 via a wireless or wire-line connection 14. In this embodiment, the server 16 comprises a plurality of software applications. The main applications can be functionally grouped as follows: (1) Content Management: optical character recognition and correction, matching, storing, indexing, sorting, categorization and text-to-speech conversion; (2) Communication: Data transmission to and from device (e.g., matching confirmation), user, publishers and advertisers; (3) Administration and Operation: user/device identification, billing, web applications publishing and management; and (4) Intelligence: Usage reporting, statistics, customer profiling.

When one or more discrete pieces of content, captured by the portable device, reach the server, the server detects the pattern of textual information and proceeds to convert the optical characters in digitized format using conventional techniques. In this process one or more strings of words are properly identified and, if necessary, automatically corrected through vocabulary functions.

The strings are then matched against digital databases 18, provided by content providers (e.g., print publishers, advertisers etc). Starting from the strings and treating them as a digital fingerprint, the system's search engine identifies the full digital text (the “parent text” or master content) that string is a part of.

To the system's user, server managed information is accessible via a password-protected web based application (“CAMS Portal”), available from any Internet enabled medium. The CAMS Portal 20 offers searching and retrieval capabilities, as well as adaptive indexation and categorization. In addition, the information can be chronologically indexed, further facilitating the retrieval process.

Through the CAMS Portal users can specify in advance certain document acquisition criteria. For example, when a string is matched with a sizeable document (like a book), a user's defined criteria dictate what portion of the entire document should be stored (like the preceding and following 5 lines, 5 pages, etc.).

In one embodiment, the taxonomy of the web-based user application is structured to deliver the following: (1) an index of categorized content, (2) a search engine, (3) audio delivery option; (4) a lead to what users with similar interests read, (5) a lead to relevant content on the Internet, and/or (6) relevant news feeds.

A range of data on users' profiles and preferences, inferred from the system usage pattern, can be made available to publishers and advertisers 22. In one embodiment this information is made available only after receiving the consent of the user.

The manner of using the present invention can be described through the following sequence.

Acquisition: at one end of the system architecture is a portable device (client) 10 incorporating, among other means, a digital camera and communication engine. As described above, the device can be either stand alone or integrated into a mobile phone, smart phone, personal digital assistant, I-pod, digital camera or other device. Content acquisition takes place when a user positions the device 10 over or points the device 10 toward a piece of printed material or target content 12, aims and clicks, thereby taking a digital picture. A laser pointer or display may be incorporated in the device 10 to facilitate the aiming and content acquisition process, as described above.

Transmission: Once captured by the device, the content can be automatically transmitted 14 to one or more servers 16 for processing. A communication engine, integrated in the portable device 10, is responsible for the transmission.

Content recognition: Upon detecting the pattern of textual content, the system's server-side proceeds to convert the optical characters to a digitized format. In this process one or more strings of words are properly identified and, if necessary, automatically corrected through vocabulary functions.

Content matching: the strings are matched against digital databases 18 made available by content providers (e.g. print publishers, advertisers, etc) using conventional matching techniques. Starting from the strings and treating them as a digital fingerprint, the system's search engine identifies the full digital text (the “parent text” or the “master content”) that string is a part of. The underlying principle at work is the non-linear relationship between the size of a given string or set of strings and the probability of finding one unique matching text for that given string or set of strings. That is, the likelihood of finding a unique matching text increases non-linearly as a function of the number of recognized words.

Delivery: the full parent text (or parts thereof, as selected by the user) is saved on a user specific portion of the server. It is now accessible and open to management by the authenticated user in a web-based format, after accessing his/her personal webpage 20. The server is capable of executing automatic indexation and categorization of content, based on adaptive algorithms. Selected content can also be converted in audio format using conventional text-to-speech technologies in order to provide users with an audio delivery option. Where appropriate, publishers may also offer users the option to download a video file related to the acquired content.

Confirmation: the camera device provides audible and/or visible confirmation of successful matching. If provided with a screen, the device may be prompted by the server to offer full identification details of the acquired text (e.g., Business Week of November 24, article title, author). Alternatively, the same details may be sent to the user's mobile phone (as a short message) or email.

Intelligence: publishers and advertisers may be provided with detailed information and statistics 22 about content acquisition and customer profiling.

The Content Acquisition and Management System (CAMS) provides a convenient and productive way of acquiring, storing, managing and consuming printed content. The repeated usage of the system over time creates a highly customized wealth of information that can be likened to a growing personal Internet. The documents stratified in the server's space allocated to each user are searchable from the user's web page. However, unlike the Internet 30, information residing on the CAMS server is directly relevant to the interests of each user. As users freely select what material to save, the information stored in the system is highly pertinent to their needs as well as informative about users' specific preferences. Spreadsheets and word processors have vastly improved our ability to organize, analyze and present data. A new frontier in personal productivity is the ability to leverage (e.g., internalize and then extract at will) the vast amount of printed information that we read and absorb. CAMS integrates different technologies (OCR, storage, searching, etc) to provide this new dimension of productivity and convenience.

Potential applications are in all personal and professional activities that require an “intellectual” effort, such as reading, studying and absorbing useful information. Such activities are typically associated with many professions: lawyers, medical doctors, managers, scientists, professors, traders, financial analysts etc. In these professions, success is often related to the ability to rapidly assimilate and manipulate relevant information. In fact, most professionals often state that one never stops learning and that staying abreast of best practices and world development is crucial for professional growth. While the Internet is always available, the retrieval of a very specific piece of information maybe time consuming. It would be convenient if one could search it in the much smaller (but more relevant) sea of personal past readings and studies. The present invention can help do this.

Another application is in the field of advanced education. Take the example of a graduate business student. The student is making a large financial investment in the education. At the end of the program he or she will go home with a degree, books, binders and, hopefully, an internalized management culture. If our student, now alum, had used CAMS in the course of her studies, she could obtain more benefit from the expensive material she has been exposed to. For example, if the student remembers that multiple regression offered very powerful tools for data analysis and she would like to refresh her memory on the topic because she would like to apply it to a real world management problem she is facing. One way to do it would be to retrieve the wealth of information from CAMS and revisit the same details she had internalized in school.

From the standpoint of commercial exploitation, it is reasonable to expect that once CAMS became part of one's professional habits, switching costs may be considerable. This is because the more it is used, the wider and more valuable the stored information becomes to the user. A consequential advantage is in the potential network externalities arising from users (like professional colleagues) sharing and synchronizing their individual CAMS databases (or parts thereof) for enhanced team productivity. For example, colleagues working in the same department or scientists working on the same project might share and synchronize their personal universe of relevant data for increased group productivity and knowledge base.

In another embodiment content consumption can take place in audio format, in addition to, or as an alternative to video. For example, a busy professional may notice a potentially insightful article in a magazine. By reading the title and glancing through the text, the individual concludes that the article is of interest. Short of time, the professional may use the present invention to capture the article. For example, the professional may activate the system, which then stores the digitized article in a private server partition for future use or reference. Later, the professional may opt to “consume” the content in audio format by downloading an audio file on an Ipod or other digital audio device. In addition, users may have the option to download one or more video files related to the acquired content, for consumption on any video enabled device, like a PC or a video Ipod.

While the above description contains many specifics, these should not be construed as limitations on the scope of the invention, but rather as an examples of one preferred embodiment thereof. Many other variations are possible, such as those described herein.

There are scaling advantages inherent to an architecture revolving around one or more servers. As technology advances in information technology and in the searching and information management field, any progress can be made available in a seamless fashion to the user base (via the web based application) just by upgrading the server. However, embodiments are conceivable whereby functions performed at server level, like, for example, optical character recognition, are instead performed at the level of the portable device.

In the preferred embodiment, content is delivered digitally to the user through a dedicated and personalized web solution. However, any other type of delivery, digital or analog, may be contemplated. For example, the user may receive an email containing a hyperlink to the master content. Alternatively, the user might opt to receive the master content in physical format or have it sent to one or more addresses (hence sharing it with selected people).

Content acquired using the invention could be delivered to users in one or more digital formats: word processing, pdf or other application.

In one embodiment, content is presented in textual form. However, content could have the form of one or more images. Upon receiving a partial image from the device, the server would proceed to match it against images stored in databases provided by content providers. One application would be applied to print advertisements of luxury goods or complex goods (e.g.: cars, jewelry etc). Upon successful matching, the system would provide users with detailed information on the captured images via email or other media and alert the advertiser to the existence of a clearly identified prospect.

The invention could be used as a payment system: the portable device could acquire and the remote server could recognize a textual or numerical code printed on a vendor receipt. The code would be generated by partnering vendors at the time of a sale. The server would recognize the code, match it against a specific vendor and communicate payment details to the user via the portable device or other portable communication device (“do you want to pay $100 to restaurant xyz?”). The user could accept to pay by inputting her secret code in the portable device and sending it back to the server. The vendor and user accounts would be automatically credited and debited through a back end clearing system. Important benefits would accrue to the user in terms of ability to monitor and manage her spending via a dedicated web based application, storing all financial transactions performed with the system.

Those of skill in the art will appreciate still additional alternative structural and functional designs for a system and a process for acquiring and managing printed content through the disclosed principles of the present invention. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as it is defined in the appended claims.

What is claimed is:

1. A method for identifying a master content, comprising the steps of:
acquiring a first portion of a target content, wherein said first portion is a portion of the target content;
transmitting said first portion;
recognizing characters in said first portion;
comparing said recognized characters to a database to identify the master content that includes said recognized characters; and
outputting the master content.

2. The method of claim 1, wherein said target content is printed material.

3. The method of claim 1, wherein said first portion includes text.

4. The method of claim 1, wherein said master content is output to a user.

5. The method of claim 4, where said master content is output in an audio format.

6. The method of claim 1, further comprising the step of providing confirmation when the master content is identified.

7. The method of claim 1, further comprising the step of transmitting first information about a first user, said first information associated with said first portion.

8. A computer program stored in a computer readable medium for performing the method of claim 1.

9. A method for identifying a master content comprising the steps of:
acquiring a first portion of a target content, wherein said first portion is a portion of the target content;
transmitting said first portion;
recognizing first data in said first portion;
comparing said recognized first data to a database to identify the master content that includes said first recognized data; and
outputting the master content.

10. The method of claim 9, wherein said target content is printed material.

11. The method of claim 9, wherein said first portion includes a photograph.

12. The method of claim 9, wherein said output is transmitted to a user.

13. The method of claim 12, where said master content is output in an audio format.

14. The method of claim 9, further comprising the step of providing confirmation when the master content is identified.

15. The method of claim 9, further comprising the step of transmitting first information about a first user, said first information associated with said first portion.

16. A computer program stored in a computer readable medium for performing the method of claim 9.

17. A system for identifying a master content, comprising:
a data acquisition device for acquiring a first portion of a target content, wherein said first portion is a portion of the target content;
a data recognition device, disposed to receive said first portion, for recognizing first data in said first portion;
an identification unit for comparing said recognized first data to a database to identify the master content that includes said recognized first data; and
transmitting device to output the master content.

18. The system of claim 17, wherein said target content is printed material.

19. The system of claim 17, wherein said first portion includes text.

20. The system of claim 17, wherein said first portion includes a photograph.

21. The system of claim 17, further comprising a confirmation unit for providing confirmation when the master content is identified.

22. The system of claim 17, further comprising an information unit for transmitting first information about a first user, said first information associated with said first portion.

23. The system of claim 17, wherein said data acquisition device includes a digital recording device.
